(19) United States
(12) Patent Application Publication
(10) Pub. No.: US 2023/0289650 A1
(43) Pub. Date: Sep. 14, 2023

(54) CONTINUOUS MACHINE LEARNING SYSTEM FOR CONTAINERIZED ENVIRONMENT WITH LIMITED RESOURCES

(71) Applicant: International Business Machines Corporation, Armonk, NY (US)

(72) Inventors: Lukasz G. Cmielowski, Kraków (PL); AMADEUSZ MASNY, Bialystok (PL); Thomas Parnell, Zürich (CH); Kiran A. Kate, Chappaqua, NY (US)

(21) Appl. No.: 17/690,458

(22) Filed: Mar. 9, 2022

(51) Int. Cl. G06N 20/00

(52) U.S. Cl. CPC G06N 20/00

(57) ABSTRACT

A continuous machine learning system includes a data generator module, a pipeline search module, a pipeline refinement module, and a pipeline training module. The data generator module obtains raw training data defining a total data size and generates a plurality of data batches from the raw training data. The pipeline search module obtains an initial data batch from among the plurality of data batches and determines a best machine learning model pipeline among a plurality of machine learning model pipelines based on the initial data batch. The pipeline refinement module receives the best machine learning model pipeline and refines the best machine learning model pipeline to generate a refined pipeline that consumes the plurality of data batches. The pipeline training module incrementally trains the refined pipeline using remaining data batches among the plurality of data batches generated after the initial data batch.

### BACKGROUND

The present invention relates generally to computing systems, and more particularly, to continuous learning systems for containerized environments with limited resources.

In today's society, consumers, businesspersons, educators, and others communicate over a wide variety of mediums in real time, across great distances, and many times without boundaries or borders. With the increased usage of computing networks, such as the Internet, humans are currently inundated and overwhelmed with the amount of information available to them from various structured and unstructured sources. Due to the recent advancement of information technology and the growing popularity of the Internet, a wide variety of computer systems have been used in machine learning.

Machine learning, a subset of artificial intelligence (AI), allows a device to automatically learn from past data without using explicit instructions, relying on patterns and inferences instead. Machine learning algorithms build a mathematical model based on sample data, known as “training data,” in order to make predictions or decisions without being explicitly programmed to perform the task. The machine learning algorithms are updated or retrained as new training data becomes available.

### SUMMARY

According to a non-limiting embodiment, a continuous machine learning system includes a data generator module, a pipeline search module, a pipeline refinement module, and a pipeline training module. The data generator module obtains raw training data defining a total data size and generates a plurality of data batches from the raw training data. The pipeline search module obtains an initial data batch from among the plurality of data batches and determines a best machine learning model pipeline among a plurality of machine learning model pipelines based on the initial data batch. The pipeline refinement module receives the best machine learning model pipeline and refines the best machine learning model pipeline to generate a refined pipeline that consumes the plurality of data batches. The pipeline training module incrementally trains the refined pipeline using remaining data batches among the plurality of data batches generated after the initial data batch.

According to another non-limiting embodiment, a computer-implemented method comprises obtaining by a data generator module raw training data defining a total data size, and generating by the data generator module a plurality of data batches from the raw training data. The method further comprises obtaining, by a pipeline search module in signal communication with the data generator module, an initial data batch from among the plurality of data batches, and determining by the pipeline search module a best machine learning model pipeline among a plurality of machine learning model pipelines based on the initial data batch. The method further comprises receiving by a pipeline refinement module in signal communication with the pipeline search module the best machine learning model pipeline, and refining by the pipeline refinement module the best machine learning model pipeline to generate a refined pipeline configured to consume the plurality of data batches. The method further comprises incrementally training by the pipeline training module the refined pipeline using remaining data batches among the plurality of data batches generated after the initial data batch.

According to yet another non-limiting embodiment, A computer program product to control continuous machine learning system to generate data batches used to determine, refine and train a best pipe line, the computer program product comprising a computer readable storage medium having program instructions embodied therewith, the program instructions executable by an electronic computer processor to control the continuous machine learning system to perform operations comprising obtaining by a data generator module raw training data defining a total data size, and generating by the data generator module a plurality of data batches from the raw training data. The method further comprises obtaining, by a pipeline search module in signal communication with the data generator module, an initial data batch from among the plurality of data batches, and determining by the pipeline search module a best machine learning model pipeline among a plurality of machine learning model pipelines based on the initial data batch. The method further comprises receiving by a pipeline refinement module in signal communication with the pipeline search module the best machine learning model pipeline, and refining by the pipeline refinement module the best machine learning model pipeline to generate a refined pipeline configured to consume the plurality of data batches. The method further comprises incrementally training by the pipeline training module the refined pipeline using remaining data batches among the plurality of data batches generated after the initial data batch.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram of a cloud computing environment according to one or more non-limiting embodiments of the invention;

FIG. 2 is a block diagram illustrating various functional abstraction layers provided by a cloud computing environment according to one or more non-limiting embodiments of the invention;

FIG. 3 is a block diagram illustrating a processing system according to one or more non-limiting embodiments of the invention;

FIG. 4 is a block diagram illustrating a continuous machine learning system configured to operate in a containerized environment having limited resources according to one or more non-limiting embodiments of the invention;

FIGS. 5A-5B depict a process flow for generating data batches used to determine, refine and train a best pipe line according to a non-limiting embodiment of the present invention; and

FIG. 6 is a flow diagram illustrating a method of operating a continuous machine learning system in a containerized environment having limited resources according to one or more non-limiting embodiments of the invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

The innovations in artificial intelligence and machine learning have resulted in an increased market demand for training systems capable of operating in containerized environments. Containerized environments such as docker image environments, for example, facilitate runtimes and images that can be conveniently deployed on any cloud provider (e.g., both private and public cloud providers).

The same market also demands the ability for machine learning training system to support larger tabular data pools. Conventional automatic machine learning trainings systems currently available in the market require that the entire data pool be directly available so that the data is passed to the training system to determine the available machine learning models. Therefore, the environment running the machine learning training system must have sufficient resources, e.g., memory, to handle the data pool. However, containerized environments typically have limited resources, e.g., limited available memory. For example, a containerized environment (e.g., a docker image) may be deployed with 16 gigabytes (GB) of memory, but the data pool may contain 100 GB of training data. Consequently, the limited resources of the docker image may not allow a conventional machine learning training system to properly train models using the entire training data, or may even crash the containerized environment.

Embodiments of the present invention overcome the shortcomings of the current methods by providing a continuous machine learning system configured to operate in a containerized environment having limited resources. The continuous machine learning system employs a pipeline search module and a pipeline refinement module to automatically determine the best pipeline among a plurality of pipelines, and then automatically refine the best pipeline to facilitate automatic and continue machine learning of records and resources assigned to the container environment.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

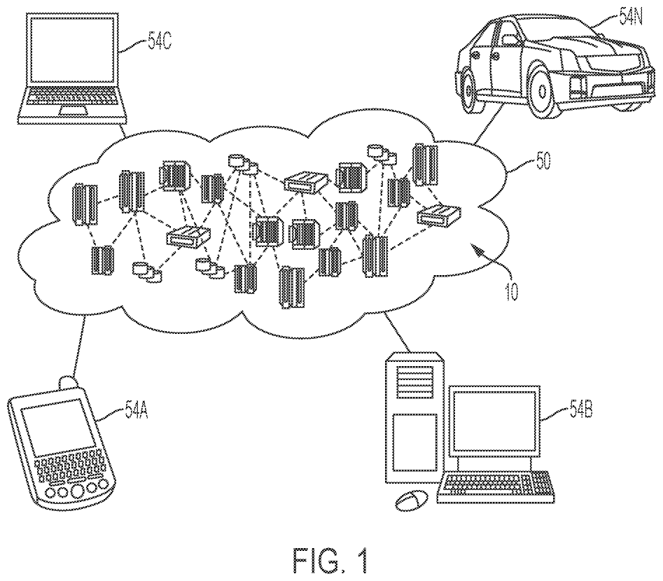

With reference now to FIG. 1, a cloud computing environment 50 is depicted according to a non-limiting embodiment of the invention. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

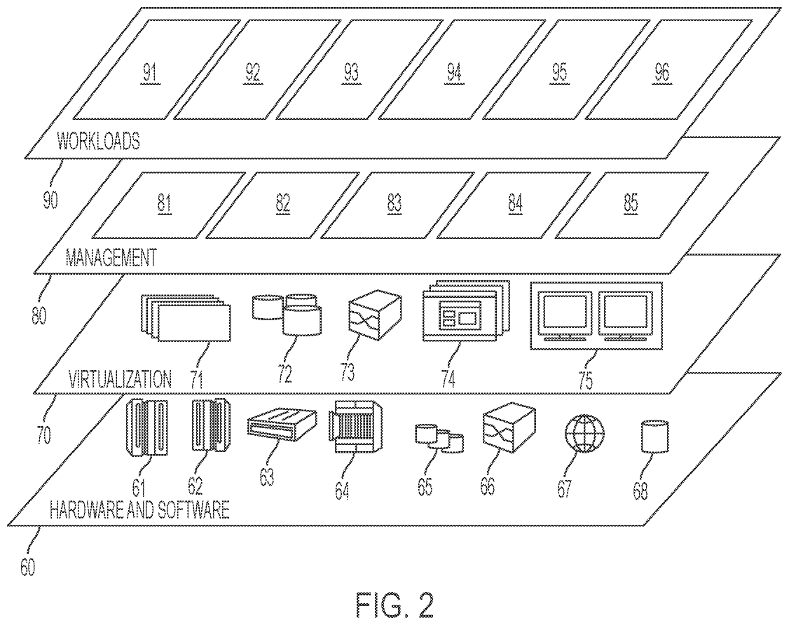

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and various workloads and functions 96 for performing continuous machine learning in a containerized environment having limited resources.

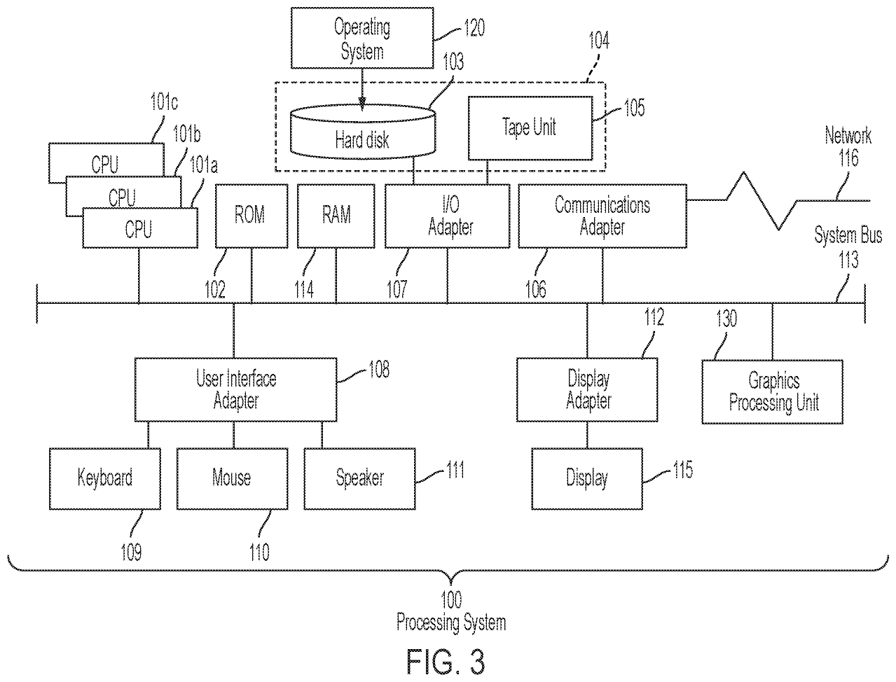

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one or more embodiments, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 3.

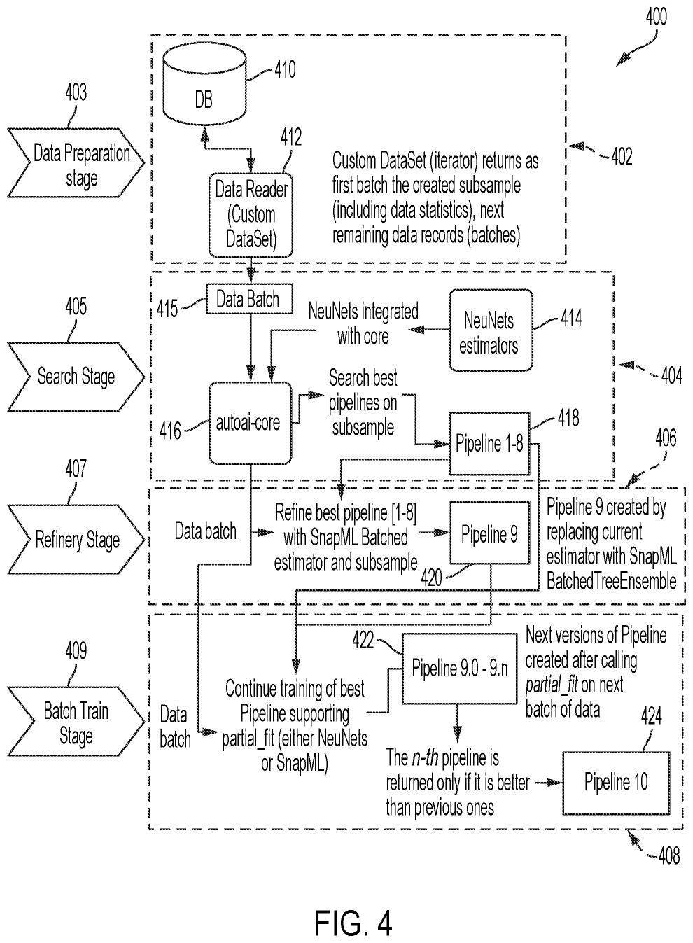

Turning now to FIG. 4, a continuous machine learning system 400 configured to perform continuous machine learning training in a containerized environment having limited resources is illustrated according to a non-limiting embodiment. The continuous machine learning system 400 includes a data generator module 402, a pipeline search module 404, a pipeline refinement module 406, and a pipeline training module 408. The data generator module 402, pipeline search module 404, pipeline refinement module 406, and pipeline training module 408 can operate in individual stages to determine a best machine learning model pipeline (referred to as a “pipeline”) among a plurality of different types of pipelines, refine the best pipeline, and continuously train the refined best pipeline using sub-sets of the raw training data (i.e., data batches). In this manner, a containerized environment having limited resources (e.g., limited RAM) can be trained using the entire raw training data and the best machine learning model pipeline without causing a container application crash.

With continued reference to FIG. 4, the data generator module 402 is implemented at a data preparate stage 403 to obtain from a database (DB) 410 raw training data defining a total data size and to create one or more data subsamples (“data batches”) from the raw training data. Each data batch has a data size that is less than the total data size of the raw training data included in the database 410. For example, if the continuous machine learning system 400 operates in a container environment with 16 gigabytes (GB) of RAM and the database 410 holds 100 GB of raw training data, the data generator module 402 can generate data batches having a size of 1 GB. The size of the data batch can be set by one or more input parameters determined by a system operator (e.g., a user).

According to one or more non-limiting embodiments, the data generator module 402 can load a batch queue 415 with a maximum number of data batches. As the continuous machine learning system 400 performs automatic machine learning, the data generator module 402 continues to load the batch queue 415 with data batches to maintain the maximum number of data batches until the training operation is stopped or the entire raw training data is exhausted from the database 410. According to one or more non-limiting embodiments, the data generator module 402 loads the batch queue 415 with a new data batch in response to outputting a loaded data batch from the batch queue 415 to the pipeline search module 404. In one or more non-limiting embodiments, the data generator module 402 can include a data reader 412 configured to determine descriptive statistics and add the descriptive statistics to each data batch. The descriptive statistics can include, but are not limited to, a distribution of categorical values. Accordingly, the pipeline search module 404, pipeline refinement module 406, and pipeline training module 408 can determine various descriptive statistics corresponding to each data batch output from the batch queue 415.

The pipeline search module 404 is implemented at a pipeline search stage 405. The pipeline search module 404 is in signal communication with the data generator module 402 to obtain an initial data batch. Using the initial data batch, the pipeline search module 404 analyzes a plurality of different types of machine learning model pipelines (referred to simply as a pipelines) operating according to different operating parameters and to determine an accuracy of each pipeline. The pipeline search module 404 determines the pipeline having a highest accuracy as the best pipeline among the plurality of pipelines.

According to one or more non-limiting embodiments, the pipeline search module 404 is configured to analyze one or more pipelines, along with corresponding metadata. A pipeline can be defined as a sequence of transformers and estimators and an ensemble of machine learning pipelines (e.g., a machine learning model pipeline as a sequence of data transformers followed by an estimator algorithm). A pipeline or a plurality of pipelines can represent or can be used to implement a machine learning model. One or more pipelines can be generated using an automated estimator engine and/or an automated model synthesizer. The pipeline search module 404 can analyze one or more of the pipelines and extracted metadata and apply a ranked score according to metadata ranking criteria and pipeline ranking criteria. In one or more non-limiting embodiments, an interactive visualization graphical user interface (“GUI”) can display the machine learning model corresponding to a given pipeline, the ensemble of a plurality of machine learning model pipelines (or combination thereof), and the rankings assigned to pipelines.

With continued reference to FIG. 4, the pipeline search module 404 includes an automated estimator engine 414, an automated machine learning (ML) engine (e.g., “autoai-core”) 416, and a pipeline bank 418. In one or more non-limiting embodiments, the automated estimator engine 414 and/or the automated ML engine 416 can be implemented as individual controllers, respectively.

The automated estimator engine 414 includes a neural network synthesis engine such as “NeuNetS” provided by IBM, which is configured to provide a plurality of different estimators. Each estimator can be defined by a machine learning (ML) algorithm such as, for example, a LGBM classifier and a XGB classifier. In one or more non-limiting embodiments of the invention, each estimator can be further defined by one or more ML enhancements. The ML enhancements include, but are not limited to, a model optimization hyperparameter (HPO-N) and a feature engineering option (e.g., FF, FE, etc.). The HPO-N enhancement aims at finding a well-performing hyperparameter configuration of a given machine learning model on a dataset at hand, including the machine learning model, its hyperparameters and other data processing steps. The feature engineering option defines a measurable input that can be used in a predictive model such as, for example, a color of an object or the sound of someone's voice, and can be used to convert raw observations into desired features using statistical or machine learning approaches.

The automated ML engine 416 is in signal communication with the data generator module 402 and the automated estimator engine 414. The automated ML engine 416 is configured to generate the plurality of pipelines based on the initial data batch and the estimators. In one or more non-limiting embodiments, the automated ML engine 416 can output the pipelines, ML models, and their ranking (e.g., individual ranked scores) in leaderboards displayed in the GUI. The leaderboards can display the pipelines and their respective estimators/parameters according to their respective rankings. For example, pipelines can be displayed in the leaderboard from highest ranking to lowest ranking.

The pipeline bank 418 is loaded with the pipelines created by the automated ML engine 416. The pipeline search module 404 can access the pipeline bank 418, select the best pipeline (e.g., highest ranked pipeline), and deliver it to the pipeline refinement module 406. In one or more non-limiting embodiments, the pipeline search module 404 can select a best pipeline in response to analyzing training results provided by the pipelines included in the pipeline bank 418. Following an initial training operation using the initial data batch, the pipelines pass test data through a sequence of data transformations (e.g., preprocessing, data cleaning, feature engineering, mathematical transformations, etc.) and use an estimator operation of the estimators (e.g., Logistic Regression, Gradient Boosting Trees, etc.) to yield predictions for the test data corresponding to each pipeline. The predictions can then be used to generate the ranking scores for each pipeline. The pipeline search module 404 can the identify the pipeline in the pipeline bank 418 with the highest ranking score as the best pipeline.

With continued reference to FIG. 4, the pipeline refinement module 406 is implemented at a refinery stage 407. The pipeline refinement module 406 is in signal communication with the pipeline search module 404 to receive sub-sets of data referred to as “data batches” generated from a large pool of raw training data, along with the best pipeline from the pipeline bank. In one or more non-limiting embodiments, the pipeline refinement module 406 includes a best pipeline buffer 420, which temporarily holds the best pipeline. Accordingly, the pipeline refinement module 406 can operate to refine the best pipeline stored in the best pipeline buffer 420 to generate a new refined pipeline that supports incremental learning (e.g., partial_fit API) and is capable of consuming input data in batches. Once the refined pipeline is generated, the pipeline refinement module 406 can deliver it to the pipeline training module 408 for continued training using one or more subsequently generated data batches as described in greater detail below.

In one or more non-limiting embodiments, the pipeline refinement module 406 refines the best pipeline by replacing the estimator of the best pipeline with a refined estimator. The refined estimator includes one or both of the Hyperparameter Optimization and the feature engineering option of the estimator, along with one or more of an additional Hyperparameter Optimization or additional feature engineering option obtained from the automated estimator engine

With continued reference to FIG. 4, the pipeline training module 408 is implemented at a batch training stage 409. The pipeline training module 408 is configured to incrementally train the refined pipeline using subsequently generated data batches obtained from the batch queue 415. In other words, the pipeline training module 408 uses the data batches output from the batch queue 415 after the initial data batch used to identify the best pipeline to incrementally train the refined best pipeline. In one or more non-limiting embodiments, the pipeline training module 408 includes a refined pipeline buffer 422, which temporarily holds the best pipeline received from the pipeline refinement module 406. Accordingly, the pipeline training module 408 incrementally trains the refined pipeline stored in the refined pipeline buffer 422 by generating one or more new versions of the refined pipeline in response to training a current version of the refined pipeline using a most-recent data batch obtained from the batch queue 415. According to one or more non-limiting embodiments, new versions of the refined pipeline can be stored in the refined pipeline buffer 422 as they are generated. In one or more non-limiting embodiments, the 408 continues training the refined pipeline until the training operation is stopped or the entire raw training data is exhausted from the database 412. Once the training of the refined pipeline, the version of the refined pipeline having the best accuracy (e.g., ranking score) is output to a completion buffer 424 for future use.

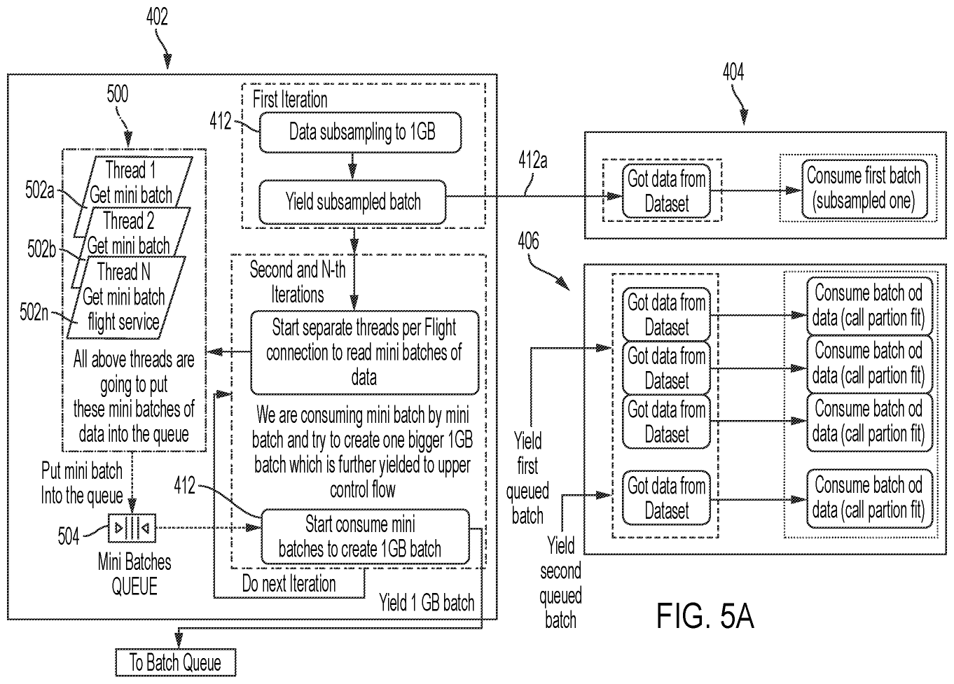

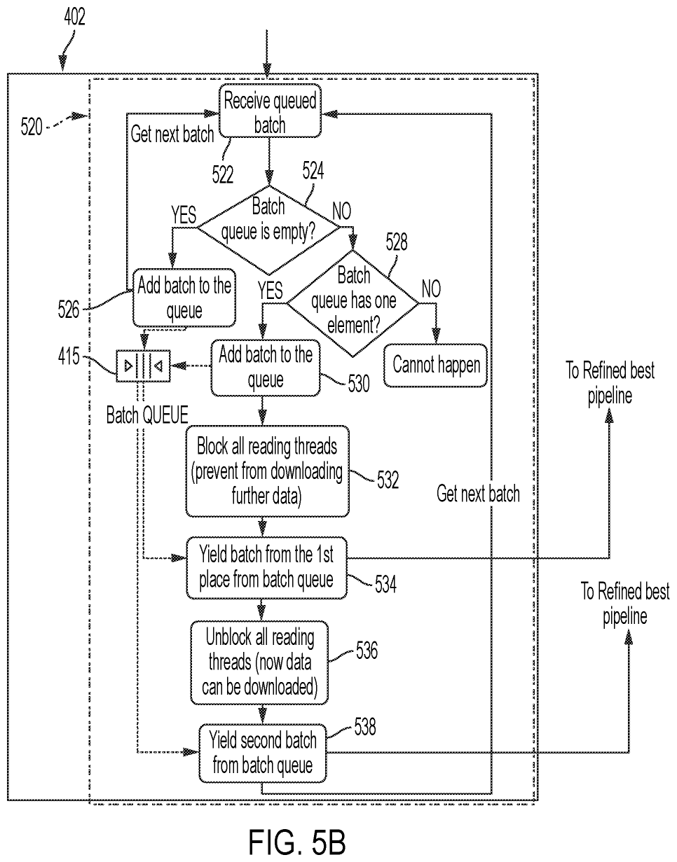

FIGS. 5A-5B depict a process flow for generating data batches used to determine, refine and train a best pipe line according to a non-limiting embodiment of the present invention. As described herein, the data generator module 402 generates data subsamples referred to as “data batches” 412 from a larger pool of raw training data. An initial iteration of the data batch 412a is provided to the pipeline search module 404. As described herein, the pipeline search module 404 utilizes the initial data batch 412a to determine the best pipeline among a plurality of available different pipelines. After determining the best pipeline, the data generator module 402 utilizes one or more subsequently generated data batches 412b-412n (e.g., the second integration a data batch 412b to the nth iteration of a data batch 412n) to refine the best pipeline and train the refined best pipeline as described herein

In one or more non-limiting embodiments, the data generator module 402 includes a mini-batch module 500 and a mini-batch queue 504. The data generator 402 utilizes the mini-batch module 500 and a mini-batch queue 504 to control the loading of data batches 412b-412n into the batch queue 415.

The mini-batch module 500 receives each iteration of a subsequently generated data batch 512b-512n and generates one or more mini-data batches 502a, 502b, 502n. For example, if the data generator module 402 generates data batches 512a-512n having a size of 1 GB, the mini-batch module 500 can generate individual mini-data batches 502a-502n each having a smaller size, e.g., each mini-data batch 502a-502n having a size of about 100 MB. The mini-data batches 502a-502n can then be stored in the mini-batch queue 504.

With continued reference to FIG. 5A, the data generator module 402 utilizes the mini-data batches 502a-502n to load the batch queue 415. In one or more non-limiting embodiments, the data generator module 402 retrieves the mini-data batches 502a-502n from the mini-batch queue 504 and combines them or “stiches” them together until generating a data batch having a size equal to the target data batch size (e.g., 1 GB). Once the target data batch size is reached, the generated data batch 412 available to be loaded into the batch queue 415.

Turning to FIG. 5B, the data generator module 402 utilizes control logic 520 to manage the loading of subsequently generated data batches 412b-412n in the data queue 415. At operation 522, the data generator module 402 obtains the most recent subsequently generated data batch 412 (referred to as the “queued data batch” 412) to be loaded in the batch queue 415. At operation 524, the data generator module 402 determines whether the batch queue 415 is empty. When the batch queue 415 is empty, the data generator module 402 loads the “queued data batch” 412 into a first position in the batch queue 415 at operation 526. Accordingly, the batch queue 415 now contains a loaded data batch 412.

When, however, the data generator module 402 determines that the batch queue 415 is not empty, the data generator module 402 proceeds confirms (i.e., by default) that the batch queue 415 currently contains a previously loaded data batch at operation 528, and loads the loads the “queued data batch” 412 into a second position in the batch queue 415 at operation 530. Accordingly, the batch queue 415 now contains two loaded data batches 412. At operation 532, the data generator module 402 temporality blocks reading any further threads to prevent obtaining any further data batches 412. At operation 534, the data generator module 402 obtains the loaded data batch 412 stored in the first queue position of the data queue 415 (referred to as the “leading data batch”) and delivers it to the pipeline refinement module 406 (see FIG. 5A). While the pipeline refinement module 406 is processing the leading data batch, the data generator module 402 can operate in parallel to obtain the loaded data batch 412 stored in the second queue position of the data queue 415 (referred to as the “lagging data batch”). In this manner, the speed at which the data batches are processed is increased.

At operation 536, the data generator module 402 unblocks reading threads so that new data batches 412 can be obtained. At operation 538, the loaded data batch stored in the second queue position of the data queue (i.e., the lagging data batch) is obtained and is delivered to the pipeline refinement module 406 for processing (see FIG. 5A). At this stage, the data queue 415 no longer contains the max number of loaded data batches. Accordingly, the data generator module 402 returns to operation 522 to obtain a new queued data batch in order to re-load the data queue 415.

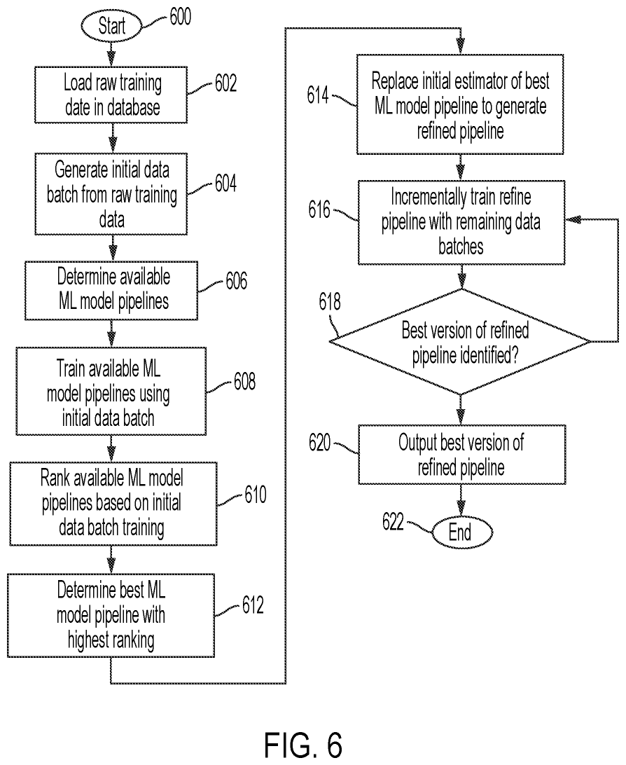

With reference now to FIG. 6, a method of performing a continuous machine learning system in a containerized environment having limited resources is illustrated according to one or more non-limiting embodiments of the invention. The method begins at operation 600, and at operation 602 raw training data is loaded in a data base to perform continuous machine learning system in a containerized environment such as, for example, a docker container image. At operation 604, a sub-set of the raw training data are used to generate an initial data batch. At operation 606, a plurality of available ML model pipelines are selected from a pipeline bank. At operation 608, the selected ML model pipelines are trained using the initial data batch and rankings for each of the selected ML model pipelines are determined at operation 610. At operation 612, the ML model pipeline with the highest ranking is determined to be the best ML model pipeline and at operation 614 the best pipeline is refined. The refinement is performed by replacing the initial estimator of the best pipeline with a refined estimator to generate a refined pipeline.

Turning to operation 616, the refined pipeline is incrementally trained using subsequently generated data batches that include sub-sets of the remaining raw training data. Each time the refined pipeline is trained with a new data batch, a new version of the refined pipeline is generated. At operation 618, a determination is made as to whether a best version of the refined pipeline is generated. When a best version of the refined pipeline is not identified, the method returns to operation 616 an continues to incrementally train the refined pipeline. When, however, the best version of the refined pipeline is identified, the best version of the pipeline is output at operation 620, and the method ends at operation 622.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A continuous machine learning system comprising:
a data generator module configured to obtain raw training data defining a total data size and to generate a plurality of data batches from the raw training data;
a pipeline search module in signal communication with the data generator module to obtain an initial data batch from among the plurality of data batches and determine a best machine learning model pipeline among a plurality of machine learning model pipelines based on the initial data batch;
a pipeline refinement module in signal communication with the pipeline search module to receive the best machine learning model pipeline and to refine the best machine learning model pipeline to generate a refined pipeline configured to consume the plurality of data batches; and
a pipeline training module configured to incrementally train the refined pipeline using remaining data batches among the plurality of data batches generated after the initial data batch.

2. The continuous machine learning system of claim 1, wherein the best machine learning model pipeline includes an initial estimator, and wherein refining the best machine learning model pipeline includes replacing the initial estimator of the best machine learning model pipeline with a refined estimator that includes the initial estimator along with one or more of an additional model hyperparameter and an additional feature engineering option.

3. The continuous machine learning system of claim 2, wherein the pipeline search module is configured to determine an accuracy of each of the machine learning model pipelines, and is configured to determine the machine learning model pipeline having a highest accuracy as the best machine learning model pipeline among the plurality of machine learning model pipelines.

4. The continuous machine learning system of claim 3, wherein the pipeline search module comprises:
an automated estimator engine configured to provide a plurality of different estimators, each estimator defined by one or a combination of a machine learning algorithm, an enhancement, and a feature engineering option; and
an automated machine learning engine in signal communication with the data generator module and the automated estimator engine, the automated machine learning engine configured to create the plurality of machine learning model pipelines based on the initial data batch and the plurality of different estimators.

5. The continuous machine learning system of claim 4, wherein the plurality of machine learning model pipelines are assigned ranking scores in response to being trained according to the initial data batch, and
wherein the pipeline search module selects the machine learning model pipelines having the highest ranking score as the best machine learning model pipeline and delivers the best machine learning model pipeline to the pipeline refinement module.

6. The continuous machine learning system of claim 5, wherein the data generator module loads a batch queue with a maximum number of data batches and continues to load the batch queue with data batches to maintain the maximum number of data batches, wherein the data generate loads the batch queue with a new data batch in response to outputting a loaded data batch from the batch queue to the pipeline search module.

7. The continuous machine learning system of claim 6, wherein incrementally training the refined pipeline includes generating a new version of the refined pipeline in response to training a current version of the refined pipeline using a most-recent data batch obtained from the batch queue.

8. A computer-implemented method comprising:
obtaining, by a data generator module, raw training data defining a total data size;
generating, by the data generator module, a plurality of data batches from the raw training data;
obtaining, by a pipeline search module in signal communication with the data generator module, an initial data batch from among the plurality of data batches;
determining, by the pipeline search module, a best machine learning model pipeline among a plurality of machine learning model pipelines based on the initial data batch;
receiving, by a pipeline refinement module in signal communication with the pipeline search module, the best machine learning model pipeline;
refining, by the pipeline refinement module, the best machine learning model pipeline to generate a refined pipeline configured to consume the plurality of data batches; and
incrementally training, by the pipeline training module, the refined pipeline using remaining data batches among the plurality of data batches generated after the initial data batch.

9. The computer-implemented method of claim 8, wherein the best machine learning model pipeline includes an initial estimator, and wherein refining the best machine learning model pipeline further includes replacing, by an initial estimator, of the best machine learning model pipeline with a refined estimator that includes the initial estimator along with one or more of an additional model hyperparameter and an additional feature engineering option.

10. The computer-implemented method of claim 9, further comprising:
determining, by the pipeline search module, an accuracy of each of the machine learning model pipelines; and
determining, by the pipeline search module, the machine learning model pipeline having a highest accuracy as the best machine learning model pipeline among the plurality of machine learning model pipelines.

11. The computer-implemented method of claim 10, further comprising:
providing, by an automated estimator engine, a plurality of different estimators, each estimator defined by one or a combination of a machine learning algorithm, an enhancement, and a feature engineering option; and
creating, by an automated machine learning engine in signal communication with the data generator module and the automated estimator engine, the plurality of machine learning model pipelines based on the initial data batch and the plurality of different estimators.

12. The computer-implemented method of claim 11, further comprising:
assigning ranking scores to the plurality of machine learning model pipelines are in response to being trained according to the initial data batch; and
selecting, by the pipeline search module, the machine learning model pipelines having the highest ranking score as the best machine learning model pipeline; and
delivering the best machine learning model pipeline to the pipeline refinement module.

13. The computer-implemented method of claim 12, further comprising:
loading, by wherein the data generator module, a batch queue with a maximum number of data batches; and
continuing to load the batch queue with data batches to maintain the maximum number of data batches,
wherein the data generate loads the batch queue with a new data batch in response to outputting a loaded data batch from the batch queue to the pipeline search module.

14. The computer-implemented method of claim 13, wherein incrementally training the refined pipeline includes generating a new version of the refined pipeline in response to training a current version of the refined pipeline using a most-recent data batch obtained from the batch queue.

15. A computer program product to control continuous machine learning system to generate data batches used to determine, refine and train a best pipe line, the computer program product comprising a computer readable storage medium having program instructions embodied therewith, the program instructions executable by an electronic computer processor to control the continuous machine learning system to perform operations comprising:
obtaining, by a data generator module, raw training data defining a total data size;
generating, by the data generator module, a plurality of data batches from the raw training data;
obtaining, by a pipeline search module in signal communication with the data generator module, an initial data batch from among the plurality of data batches;
determining, by the pipeline search module, a best machine learning model pipeline among a plurality of machine learning model pipelines based on the initial data batch;
receiving, by a pipeline refinement module in signal communication with the pipeline search module, the best machine learning model pipeline;
refining, by the pipeline refinement module, the best machine learning model pipeline to generate a refined pipeline configured to consume the plurality of data batches; and
incrementally training, by the pipeline training module, the refined pipeline using remaining data batches among the plurality of data batches generated after the initial data batch.

16. The computer program product of claim 15, wherein the best machine learning model pipeline includes an initial estimator, and wherein refining the best machine learning model pipeline further includes replacing, by an initial estimator, of the best machine learning model pipeline with a refined estimator that includes the initial estimator along with one or more of an additional model hyperparameter and an additional feature engineering option.

17. The computer program product of claim 16, further comprising:
determining, by the pipeline search module, an accuracy of each of the machine learning model pipelines; and
determining, by the pipeline search module, the machine learning model pipeline having a highest accuracy as the best machine learning model pipeline among the plurality of machine learning model pipelines.

18. The computer program product of claim 17, further comprising:
providing, by an automated estimator engine, a plurality of different estimators, each estimator defined by one or a combination of a machine learning algorithm, an enhancement, and a feature engineering option; and
creating, by an automated machine learning engine in signal communication with the data generator module and the automated estimator engine, the plurality of machine learning model pipelines based on the initial data batch and the plurality of different estimators.

19. The computer program product of claim 18, further comprising:
assigning ranking scores to the plurality of machine learning model pipelines are in response to being trained according to the initial data batch; and
selecting, by the pipeline search module, the machine learning model pipelines having the highest ranking score as the best machine learning model pipeline; and
delivering the best machine learning model pipeline to the pipeline refinement module.

20. The computer program product of claim 19, further comprising:
loading, by wherein the data generator module, a batch queue with a maximum number of data batches; and
continuing to load the batch queue with data batches to maintain the maximum number of data batches,
wherein the data generate loads the batch queue with a new data batch in response to outputting a loaded data batch from the batch queue to the pipeline search module,
wherein incrementally training the refined pipeline includes generating a new version of the refined pipeline in response to training a current version of the refined pipeline using a most-recent data batch obtained from the batch queue.
